(19) United States
(12) Patent Application Publication
(10) Pub. No.: US 2016/0101590 A1
(43) Pub. Date: Apr. 14, 2016

(54) COMPOSITE SHEET WITH EMBEDDED MESH LAYER

(71) Applicant: Interface Performance Materials, Inc., Lancaster, PA (US)

(72) Inventors: Jeffrey A. Kane, Elizabethtown, PA (US); Jeffery L. Barrall, Lititz, PA (US); Kevin L. Meyers, Manheim, PA (US)

(21) Appl. No.: 14/878,841

(22) Filed: Oct. 8, 2015

Related U.S. Application Data
(60) Provisional application No. 62/062,384, filed on Oct. 10, 2014.
(60) Provisional application No. 62/104,714, filed on Jan. 17, 2015.

(51) Int. Cl. B32B 5/10; D21J 1/06; D21J 1/04; B32B 5/02; B32B 3/30

(52) U.S. Cl. CPC B32B 5/10; B32B 5/028; B32B 5/022; B32B 3/30; D21J 1/04; D21J 1/06; B32B 2250/20; B32B 2260/021; B32B 2262/062; B32B 2262/101; B32B 2262/0253; B32B 2262/14; B32B 2307/726; B32B 2307/54; B32B 2419/06; B32B 2405/00; B32B 2553/00

(57) ABSTRACT

A composite sheet includes a base sheet comprising a single ply of dried stock material that includes non-woven natural fibers or non-woven synthetic fibers or both, with the base sheet having a top surface, a bottom surface, and a base sheet thickness between the top surface and the bottom surface. The composite sheet also includes a scrim formed from a plurality of intersecting strands, with the thickness of the scrim, as defined at the intersections of the strands, being at least one third the base sheet thickness, and with at least a majority portion of the thickness of the mesh layer being embedded within the thickness of the base sheet to provide reinforcement for the base sheet.

### CROSS-REFERENCE TO RELATED APPLICATIONS

This application claims the benefit of U.S. Provisional Patent Application No. 62/062,384, filed on 10 Oct. 2014, and U.S. Provisional Patent Application No. 62/104,714, filed on 17 Jan. 2015, each of which is incorporated by reference in its entirety herein and for all purposes.

### FIELD

The present invention relates generally to thin sheet materials formed from wet stock mixtures of non-woven fibers and combined with a reinforcing mesh layer for increased tear resistance and strength.

### BACKGROUND

Dry, low-cost sheet materials formed from wet stock mixtures of non-woven fibers have broad application in commerce. Some representative applications include fiberboard or cardboard used for packaging, felt base layers that are saturatable with an asphalt or bitumen-based material for use as roofing underlayments to provide an impermeable barrier, thin substrates that can be subsequently coated with an adhesive and a release liner to form a rollable tape, and the like. One common characteristic of such sheet materials, however, is that they can be easily tom when placed under out-of-plane shear stresses or high in-plane tensile stresses. While in some applications this susceptibility to tearing is not a significant concern, in other applications a base layer of sheet material is combined with an additional reinforcement layer to form composite sheets having increased tensile strength and resistance to tearing. The reinforcement layer is typically stitched or laminated to one or both sides of the base sheet layer. Although these composite sheets have generally proven useful in many aspects, they are more generally costly than un-reinforced sheets due to the additional manufacturing steps and materials, and in certain applications have experienced failures through delamination of the reinforcement layer from the base sheet layer.

A need therefore exists for an improved composite sheet material that includes a reinforcement layer combined with a base layer formed from a wet stock mixture that is easier to manufacture, less costly, and with a reduced propensity for delamination. It is toward the provision of such a composite sheet material the present application is primarily directed.

### SUMMARY

Briefly described, a composite sheet includes a base sheet comprising a single ply of dried stock material that includes non-woven natural fibers or non-woven synthetic fibers or both, with the base sheet having a top surface, a bottom surface, and a base sheet thickness between the top surface and the bottom surface. The composite sheet also includes a mesh layer formed from a plurality of intersecting or interwoven strands, with the thickness of the mesh being defined at the intersections, with the mesh layer thickness being at least ⅓ the base sheet thickness and with at least a majority portion of the thickness of the mesh layer being embedded within the thickness of the base sheet to provide reinforcement for the base sheet. In one aspect the mesh layer is substantially embedded within the base sheet with an upper surface of the mesh layer at the top surface of the base sheet, so that the pattern of the embedded mesh layer projects upward through the dried stock material at the top surface of the base sheet.

In another embodiment of the present disclosure, a composite sheet includes a base sheet comprising a single ply of dried stock material that includes at least 50 percent non-woven natural fibers such as cellulose, with the base sheet having a top surface, a bottom surface, and a base sheet thickness between the top surface and the bottom surface. The composite sheet further includes a scrim extending across a width and a length of the base sheet and formed from a plurality of intersecting strands of multifilament fiberglass material to define a scrim thickness at the intersections thereof, with the scrim being substantially embedded within an upper portion of the base sheet with the pattern of the embedded intersecting strands projecting upward through the dried stock material at the top surface of the base sheet. In one aspect the scrim thickness is at least about ⅓ the base sheet thickness, and in another aspect the dried stock material has a kerosene absorption number that is 120 or greater.

Yet another embodiment of the disclosure comprises a method of making a composite sheet that includes the steps of depositing aqueous stock material comprising at least one of non-woven natural fibers and non-woven synthetic fibers onto a translating wire run to form a wet base layer having a thickness and a top surface, followed by setting a mesh layer having a mesh layer thickness into the wet base layer prior to reaching the wet line at which the aqueous stock material transitions into a consolidated semi-solid material. The mesh layer is set into the wet base layer at least until a majority portion of the mesh layer thickness is embedded within the aqueous stock material below the top surface of the wet base layer. The method further includes passing the wet base layer with the embedded mesh layer through a press section of rollers to define a damp composite sheet, followed by passing the damp composite sheet through a dryer section to form a composite sheet comprising the mesh layer and dried stock material having a top surface, a bottom surface, and a sheet thickness between the top surface and the bottom surface, with the mesh layer thickness being at least ⅓ the sheet thickness and with at least a majority portion of the mesh layer thickness being embedded within the sheet thickness.

### BRIEF DESCRIPTION OF THE DRAWINGS

FIG. 1 is a perspective view of a composite sheet or substrate, in accordance with a representative embodiment of the disclosure.

FIG. 2A is a cross-sectional side view of the composite sheet of FIG. 1, as viewed from section line A-A.

FIG. 2B is a cross-sectional side view of the composite, in accordance with another representative embodiment.

FIGS. 3A-3D are cross-sectional side views of the composite sheet, in accordance with additional representative embodiments.

FIGS. 4A-4D are top views of a mesh layer, in accordance with various other representative embodiments.

FIG. 5 is a schematic view of a manufacturing system and process for making the composite sheet, in accordance with yet another representative embodiment.

FIG. 6 is a schematic view of a manufacturing system and process for making the composite sheet, in accordance with another representative embodiment.

FIG. 7 is a side view of a roller that can be used in the manufacturing system and process of FIG. 6, in accordance with yet another representative embodiment.

FIG. 8 is an end view of one of the plurality of circular wafers that together form the roller of FIG. 7.

FIG. 9 is a side view of a manufacturing system and process for making the composite sheet, in accordance with another representative embodiment.

Those skilled in the art will appreciate and understand that, according to common practice, various features of the drawings discussed below are not necessarily drawn to scale, and that dimensions of various features and elements of the drawings may be expanded or reduced to more clearly illustrate the embodiments of the present invention described herein.

### DETAILED DESCRIPTION

The following description is provided as an enabling teaching of exemplary embodiments of a composite sheet and one or more methods for making the composite sheet. Those skilled in the relevant art will recognize that changes can be made to the described embodiments, while still obtaining the beneficial results. It will also be apparent that some of the desired benefits of the described embodiments can be obtained by selecting some of the features of the embodiments without utilizing other features. In other words, features from one embodiment or aspect may be combined with features from other embodiments or aspects in any appropriate combination. For example, any individual or collective features of method aspects or embodiments may be applied to apparatus, product or component aspects, or embodiments and vice versa. Accordingly, those who work in the art will recognize that many modifications and adaptations to the embodiments described are possible and may even be desirable in certain circumstances, and are a part of the invention. Thus, the present disclosure is provided as an illustration of the principles of the embodiments and not in limitation thereof, since the scope of the invention is to be defined by the claims.

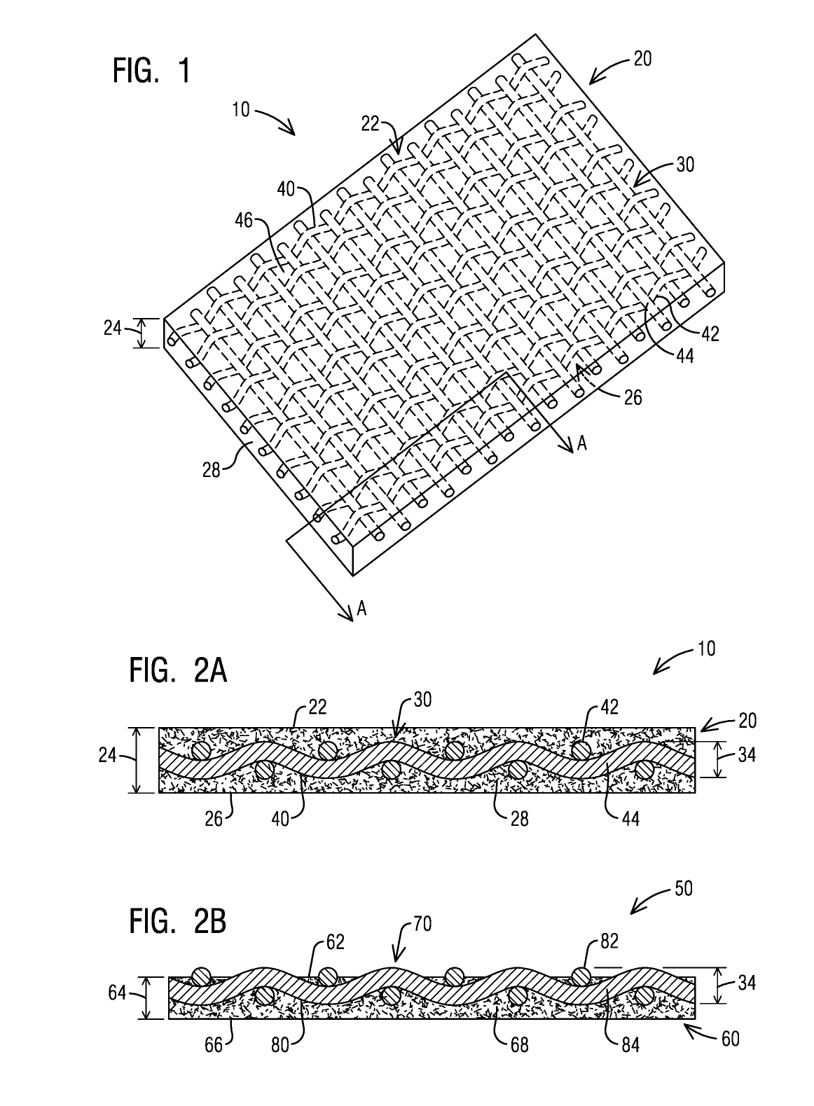

Illustrated in FIGS. 1-9 are representative embodiments of a composite sheet and one or more methods for making the composite sheet. As described below, the composite sheet can provide several significant advantages and benefits over other composite sheet products that can be used directly as packaging wrap, flooring felts and/or inner layers for flooring, or gasket material, or that can serve as a substrate for a variety of products or in various applications, including but not limited to roofing underlayments, building wraps, flooring felts and/or inner layers for flooring, packaging wraps, tarps, tapes, gaskets and the like. However, the recited advantages are not meant to be limiting in any way, as one skilled in the art will appreciate that other advantages may also be realized upon practicing the present disclosure.

As shown in FIGS. 1 and 2A, the composite sheet 10 of the present disclosure generally includes a base sheet 20 comprising a single ply of dried stock material 28 having a top surface 22, a bottom surface 26, and a base sheet thickness 24 between the top surface and the bottom surface. The composite sheet 10 further includes a mesh or mesh layer 30 that is embedded, either partially or fully, at a predetermined height within the base sheet 20. For instance, the mesh layer 30 of the composite sheet 10 shown in FIG. 1 is drawn in dashed lines to illustrate that the mesh layer 30 can be entirely embedded within the body of the base sheet 20 so that it is not visible from either side of the composite sheet.

The mesh layer 30 can also have a mesh layer thickness 34 that is a substantial percentage of the base sheet thickness 24. For example, as shown in FIG. 2A, in one aspect the thickness 34 of the mesh layer 30 can be equal to or greater than ⅓ the thickness 24 of the base sheet 20. In other embodiments the mesh layer thickness 34 can be equal to or greater than ½ or ¾ the base sheet thickness 24, or substantially equal to or even slightly greater than the thickness 24 of the base sheet 20 after drying. Furthermore, in absolute values the base sheet can have a thickness that ranges from about 0.005 inches to about 0.062 inches, while the mesh layer can have a thickness that ranges from about 0.005 inches to about 0.030 inches.

In one embodiment the material 28 of the base sheet 20 initially comprises an aqueous or wet stock mixture of non-woven cellulose fibers, polypropylene particles or fibers, and a latex binder, in addition to other components. The stock mixture can subsequently be formed, pressed and dried into a solid paper-based structure. The cellulose fibers can come from a variety of sources including, for example, northern bleached softwood kraft (NBSK). As would be appreciated by one of skill in the art, however, additional types of natural fibers may also be used as the non-woven fiber component of the stock material, including but not limited to cotton, flax, hemp, jute, and straw, as well as softwood or hardwood chemical pulps produced using one of the Kraft, sulfite, dissolving, and semi-chemical pulping processes, and the like. Mechanical pulps produced from the stone groundwood, refiner mechanical (RMP), and thermomechanical (TMP) pulping processes, and the like, may also be used.

It is also contemplated that natural cellulose fibers from recycled paper, paperboard and other recycled wood-based products can be included as a cost-effective fiber component for the wet stock mixture. For example, in one aspect recycled cellulose fibers can have particular application in more economical or lower cost embodiments, such as the formation of saturatable composite sheets or substrates configured for use as roofing underlayments. In other aspects the recycled cellulose fibers may be particularly useful for inclusion within an untreated composite sheet application, such as a lower cost protective packaging wrap. Furthermore, it is to be appreciated that other compositions and applications for wet stock mixtures that include recycled and/or virgin fiber materials, are also possible and shall be considered to fall within the scope of the present disclosure.

The polypropylene component of the stock material 28 can also be virgin or recycled, although recycled polypropylene generally provides a significant cost advantage with many of the foreseen applications for the composite sheet 10. Alternatives to the polypropylene particle or fiber component can include nylon fiber, polyester fiber, aramid fiber, carbon fiber, and acrylic fiber, and the like.

Similarly, the latex component used to bind the fibers and particles together to form the paper-based base sheet 20 may be selected from a variety of latex formulations, depending on the intended application for the composite sheet 10. In one particular embodiment the latex can comprise a caboxylated styrene butadiene rubber latex (XSBR). However, other latex types may also have application with the material 28 of the base sheet 20 and are considered to fall within the scope of the present disclosure, including but not limited to noncarboxylated styrene butadiene latex (SBR), acrylonitrile butadiene latex (NBR), acrylic latex, polychloroprene latex, as well as anionic and cationic starches, and the like.

Additional components of the stock material 28 of the base sheet 20 can include, but are not limited to, chopped fiberglass fibers, a wet strength resin, a sizing agent, and an antioxidant. For example, Table 1 is a list of the various components of the base sheet material and their weight percentages for one embodiment of the composite sheet that is configured to be saturated or impregnated by a second material. In this embodiment the dried, solid matrix material that forms the “saturating” base sheet can include interconnected pores and voids that allow the second material, in liquid form, to flow into the body of the base sheet. In one aspect, the saturating base sheet composition disclosed in Table 1 can be especially useful for saturation or impregnation with an asphalt or other bitumen-based material to form an impervious but breathable roofing underlayment, as known to one of skill in the art in the construction industries. It will be understood that the weight percent of the components shown in FIG. 1 is based on the composition of the stock material that does not include water, or rather after the drying and removal of substantially all of the water from the aqueous or wet stock material to form the dried solid sheet material and prior to the application of any new saturating fluids such as the asphalt or bitumen-based material described above.

TABLE 1
Saturating Base Sheet

| Component | Weight % |
|---|---|
| Cellulose - NBSK | 72.5 |
| Recycled Polypropylene | 15.0 |
| Chopped Fiberglass | 6.0 |
| Wet Strength Resin | 0.30 |
| AKD Sizing Agent | 0.0 |
| XSBR Latex | 6.0 |
| Antioxidant | 0.20 |

Alternatively, Table 2 is a list of the various components of the base sheet material and their weight percentage in another embodiment for the composite sheet that is not configured for saturation or impregnation by the second material, but is instead substantially impervious to the second material and therefore configured to receive the second material as a coating applied to one or both sides of the base sheet. In this embodiment the dried, solid matrix material of the “coating” base sheet can form substantially continuous outer surfaces that restrict or prevent the flow of the second material into the body of the base sheet, with an additional sizing agent component and an increased amount of latex serving to reduce the porosity and to decrease the affinity of the base sheet to water. In one aspect, the coating base sheet composition disclosed in Table 2 can be especially useful for receiving and providing structural support to the second material that can be applied as a membrane or film.

TABLE 2
Coating Base Sheet

| Component | Weight % |
|---|---|
| Cellulose - NBSK | 59.9 |
| Recycled Polypropylene | 25.2 |
| Chopped Fiberglass | 2.8 |
| Wet Strength Resin | 0.99 |
| AKD Sizing Agent | 0.55 |
| XSBR Latex | 10.2 |
| Antioxidant | 0.36 |

As shown in Tables 1 and 2 above, the stock material 28 can include chopped fiberglass fibers that, along with the cellulose fibers, can become randomly oriented within the stock material during the mixing and forming steps of the manufacturing process. In one aspect the cellulose and/or fiberglass fibers can be fibrillated to expand their branched structure and increase their surface area, thereby raising the degree of mechanical entanglement and interconnection between the base sheet 20 and the mesh layer 30. Increasing the interconnection between the base sheet 20 and the mesh layer 30 allows for any sheer loading applied between the top surface 22 or the bottom surface 26 of the composite sheet 10, as well as any axial (i.e. longitudinal) loading applied to the edges of the composite sheet, to be more effectively transferred to the reinforcing mesh layer 30 that is better adapted to carry the externally-applied loads without tearing or rupture.

In addition, in yet another embodiment the base sheet material can comprise 100% fibers, including but not limited to the natural cellulose fibers described above, after the drying and removal of substantially all of the water from the aqueous stock material to form the solid sheet material.

With continued reference to FIGS. 1 and 2A, in one aspect the reinforcing mesh or mesh layer 30 of the composite sheet 10 can be a scrim 40 of intersecting strands 42, 44, with each strand being formed from one or more synthetic materials (e.g. fiberglass, aramid, polypropylene, and the like) having a high tensile strength that resists stretching in a longitudinal direction while remaining bendable in a direction that is transverse to the longitudinal direction. It will be appreciated that the synthetic strands can be monofilament or multifilament structures made through any of a wide variety of manufacturing methods known in the art. Alternatively, in other embodiments the strands can comprise multifilament threads or yarns made from woven natural fibers such as cotton or hemp. And in some applications it may be preferable for the reinforcing mesh layer to comprise intersecting wires formed from a metallic material, such as stainless steel, which can provide a very high tensile strength while being bendable out-of-place to the plane of the scrim.

When the intersecting strands 42, 44 are woven or interlaced together, such as with the under-and-over interlacing shown in FIG. 1, the strands can together form the fabric-like scrim 40 that will bend and roll out-of-plane with the composite sheet 10 while providing dimensional integrity that resists stretching and tearing along or within the plane of the composite sheet 10. As described in more detail below, moreover, the interwoven strands 42, 44 of the scrim 40 can also define gaps or apertures 46 of large enough size to allow the mesh layer 30 to be readily pushed or driven into the aqueous stock material 28 during the formation stage of the composite sheet 10.

FIG. 2B illustrates another embodiment of the composite sheet 50 that includes a mesh layer 70, such as scrim 80, having a mesh layer thickness 74 that is substantially equal to the thickness 64 of the base sheet 60, and that may also be offset toward one of the top surface 62 or bottom surface 64 of the base sheet 60 so that a minority portion of the strands 82, 84 of the scrim 80 protrude outward from the surface of the dry base sheet material 68 after formation of the composite sheet 50.

In some applications the protruding structures can be desirable for providing friction between the composite sheet and an adjacent surface that resists any relative sliding movement between the two surfaces. Nevertheless, in other aspects (not shown), the scrim 80 may also be centered within the base sheet 60 so that the top and bottom surfaces of the base sheet 60 are substantially co-planar with the upper surface and lower surface of the mesh layer 70.

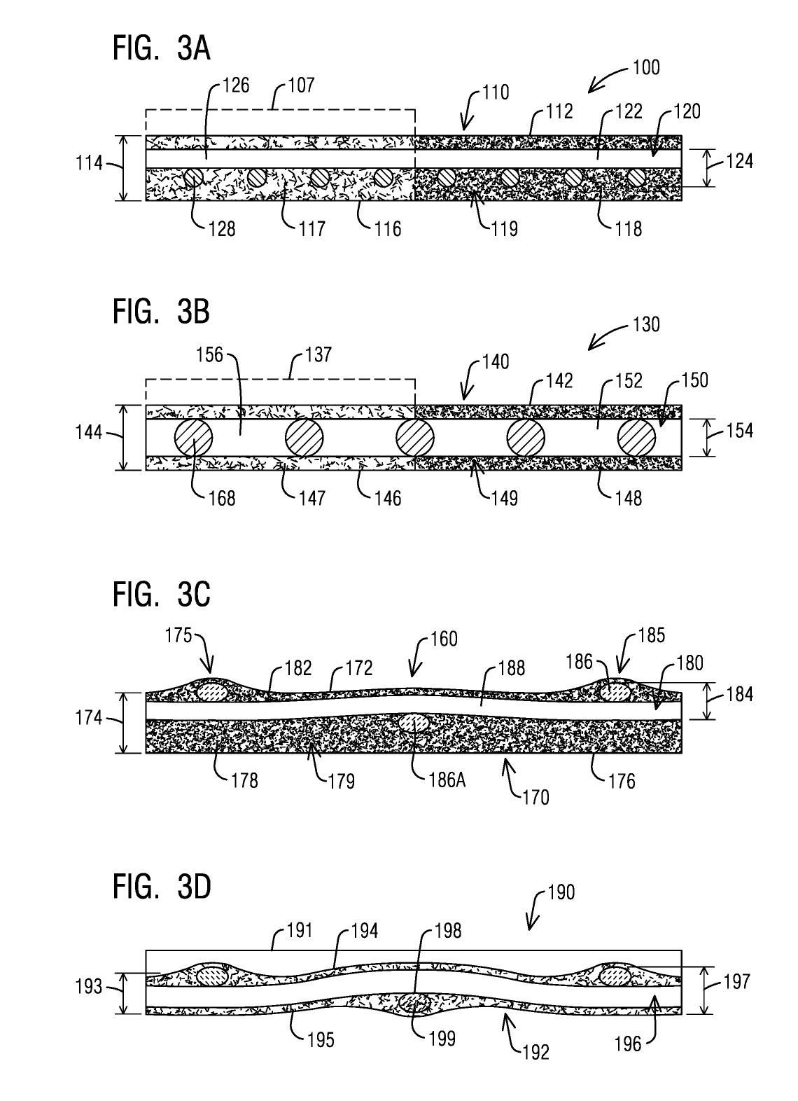

In another embodiment of the composite sheet 100 shown in FIG. 3A, the mesh layer 120 can be a non-woven scrim 122 of intersecting strands 126, 128 in which the multifilament or monofilament synthetic strands 126, 128 lay on top one another and are thermally bonded or fused and held together chemically (e.g. with an adhesive), rather than interwoven mechanically. In one aspect the mesh layer 120 can have a mesh layer thickness 124 that is less than the base sheet thickness 114, with at least one side of the mesh layer 120 being interior to the base sheet 110 and spaced from a nearest of the top surface 112 or bottom surface 116.

In yet another embodiment of the composite sheet 130 shown in FIG. 3B, the mesh layer 150 may also comprise a screen 152 formed from a flexible polymer material. In one aspect the screen 152 can further comprises a plurality of integrally-formed intersecting segments 156, 158 that have been molded together to provide a continuous reinforcement structure that resists deformation along the plane of the screen 152 while remaining bendable or rollable in a direction that is out-of-plane to the plane of the screen 152. In one aspect the mesh layer 150 can have a mesh layer or screen thickness 154 that is less than the base sheet thickness 144, with at least one side of the mesh layer 150 being interior to the base sheet 140 and spaced from a nearest of the top surface 142 or bottom surface 146 of the base sheet 140. In addition, while the intersecting segments 156, 158 are depicted in FIG. 3B as having rounded cross-sectional profiles or shapes, it will be appreciated that a molded screen 152 can include intersecting segments formed with a variety of cross-sectional profiles, including but not limited to rectangular or oblong shapes, that can facilitate the bending of the mesh layer 150 in an out-of-plane direction while increasing the resistance to deformation and tearing along or within the plane of the screen 152.

FIG. 3C illustrates yet another embodiment of the composite sheet 160 in which embedded mesh layer 180 has a mesh layer thickness 184 that is a substantial percentage of the thickness 174 of the base sheet 170, in this example between about ⅓ and ½ of the base sheet thickness 174. In addition, the mesh layer 180 may not be centered, but instead can be positively embedded within the base sheet 170 at a predetermined height that is generally offset toward the top surface 172, so that the upper surface 182 of the mesh layer 180 is positioned at or proximate to the top surface 172 of the base sheet. In this configuration the dried stock material 178 of the base sheet 170 can still cover substantially all of the strands 186, 188 of the mesh layer 180, but with the presence of the strands bulging the stock material upward so that pattern 185 of the embedded mesh layer 180 projects upward through the dried stock material 178 at the top surface 172 of the base sheet 170. In this way the mesh layer 180 can be substantially embedded within the base sheet 170 so as to provide the composite sheet 160 with the desired reinforcement and structural performance, but with the projecting pattern of the mesh layer also providing a friction surface that can improve traction in particular applications, such as the roofing underlayment application discussed in more detail below.

FIG. 3D illustrates yet another embodiment of the composite sheet 190 in which the base sheet 192 has a base sheet thickness 193 that is more or less equal to the thickness 197 of the mesh layer 196 when the base sheet 192 is still a layer of aqueous stock material during the initial stages of the manufacturing process, with the aqueous stock material flowing around and in between the strands 198, 199 to fill the spaces and form a continuous barrier upon consolidation. However, the base sheet material can experience shrinkage within the spaces between the strands 198, 199 during subsequent drying steps so that the average thickness 193 of the base sheet 192 can be slightly less then the thickness 197 of the mesh layer 196 at the “nodes” where the strands intersect one another. In some aspects the dried stock material 191 can continue to extend over the nodes, while in other aspects the exposed surfaces of the intersecting strands of the mesh layer 196 can protrude outwardly from the top surface 194 or bottom surface 195 of the dried base sheet 192 after the formation of the composite sheet 190 is complete. In either case the protruding pattern of the mesh layer 196 can be formed across both the upper 194 and lower 195 surfaces of the composite sheet that can be useful for improving the traction between the composite sheet 190 and one or more adjacent surfaces or objects.

Also illustrated in FIGS. 3A-3B is the aspect of the base sheet materials 118, 148 of composite sheets 100, 130 being saturated or impregnated with one or more second materials 119, 149, such as asphalt or other bitumen-based material, to form a final sheet-like product such as a roofing underlayment or a flooring felt. For example, in one aspect the amount of refining of the cellulose fibers of the base sheet material 118, 148 (such as the cellulose NBSK component of the saturating base sheet composition shown in Table 1) can be limited, resulting in coarser fibers that increase the porosity and decrease the density of the base sheet materials 118, 148. This, in turn, can lead to an increased capacity for absorbing asphalt or other bitumen-based material, the degree of which can be quantified with an ASTM D727-96 (2006) Standard Test for a Kerosene Absorption Number of Roofing and Flooring Felt. For instance, it has been found by the inventors that base sheet materials 118, 148 with coarser fibers and increased porosity can achieve kerosene absorption numbers greater than 120, and can be saturated with asphalt to a targeted pick-up weight of 100% to 110% of the initial, unsaturated weight of the composite sheet while running the composite sheets 100, 130 through the saturation machinery at typical manufacturing speeds.

It has also been found by the inventors, however, that it is more difficult to embed a mesh layer 120, 150 within an aqueous or wet stock mixture with coarse cellulose fibers than with refined cellulose fibers. This is because the coarse fibers tend to resist or block the passage of the strands of the mesh layer through the aqueous stock mixture, rather than flow around the strands. Therefore, a manufacturing process or method with particular capabilities for positively setting the mesh layers 120, 150 at a predetermined height within a wet base layer regardless of the coarseness of the cellulose fibers, as described in more detail below, can be utilized to form the dried saturating composite sheets 100, 130 with embedded mesh reinforcement of FIGS. 3A and 3B.

Alternatively, the base sheets 110, 140 of composite sheet embodiments 100, 130 may comprise less-pervious or impervious non-saturating base sheet materials 117, 147, such the coating base sheet composition shown in Table 2, having more refined cellulose fibers that decrease the porosity and increase the density of the base sheet materials 117, 147. In this way the base sheets 110, 140 can be adapted to receive one or more coatings 107, 137, respectively, upon an outer surface without little or no penetration of the coating material into the matrix of the base sheet material 117, 147.

Whether the base sheets are formed from a pervious and saturatable material or a less-pervious or impervious non-saturating material, in each embodiment the mesh layers 120, 150 can provide internal reinforcement to the base sheets 110, 140 that endow the composite sheets 100, 130 with improved dimensional integrity and opposition to stretching within the plane of the composite sheet, as well as resistance to tearing by sheer stresses that may be applied either along or transverse to the plane of the composite sheet.

For instance, in one exemplary embodiment of the composite sheet 160 shown in FIG. 3C having particular application as a roofing underdayment, the base sheet 170 can comprise a saturating or pervious base sheet material 178 with a base sheet thickness 174 of about 0.020 inches and a kerosene absorption number that generally ranges between 120 and 125, or above. In addition, the mesh layer 180 can comprise a non-woven scrim 182 of intersecting strands 186, 188 of multi-filament fiberglass extending across the width and the length of the base sheet 170, with each strand having a diameter of about 0.005 inch. In one aspect all the strands in the scrim 182 aligned in one direction 186, 186A can be attached in alternating fashion with an adhesive to the upper sides and lower sides of the strands aligned in the other direction 188. In addition, the individual glass filaments in the fiberglass strands can often separate and spread apart from each other to give the strand a flattened oval-shaped cross-section, especially at the intersection or nodes where the two stands connect. In this way the thickness 184 of the mesh layer 180, when measured at the nodes, can generally range from about 0.007 inches to 0.010 inches, or about ⅓ to ½ the thickness 174 of the base sheet 170.

It has been found that this combination of features and properties can result in a composite sheet or substrate 160 for a roofing underlayment that can be easily saturated with a second material 179, such as asphalt or other bitumen-based material, to form a thin and rollable moisture barrier that is easy to handle while providing high dimensional integrity along with superior resistance to both water and tearing. In addition, in one aspect the base sheet material 178 can be formed with a high percentage of low cost recycled cellulose fibers, and can also be saturated at typical manufacturing line speeds known in the art, resulting in a roofing underlayment that is superior in construction while being comparable in cost to other types of roofing underlayments presently available in the art.

FIG. 3D illustrates yet another embodiment for the composite sheet 190 that can incorporate a thin, non-woven scrim 196 of intersecting multi-filament fiberglass strands 198, 199 in which one or more coatings, such as an adhesive layer 191, can be applied to one surface 194 of the composite sheet 190 for subsequent application as a tape. For example, in one aspect both the thickness 193 of the base sheet 192 and the thickness 197 of the scrim 196 can be about 0.007 inches, resulting in a light-weight, high-strength substrate for tape having superior resistance to stretching and tearing.

In yet another aspect of the present disclosure, it is to be appreciated that the various embodiments of the composite sheets illustrated in FIGS. 2A-2B and 3A-3D may also be suitable as internally-reinforced final composite products without impregnation or coating. Such applications can include, among others, packaging wrap, linerboard for corrugated fiberboard containers, substrates for gaskets, and substrates for tape. Depending upon the application, moreover, the components of the stock material used to form the base sheets 20, 60, 110, 140, 170 and 192 can also be configured to provide a desired degree of impermeability or permeability, so as to block out or absorb any fluids that may be present in the intended environment.

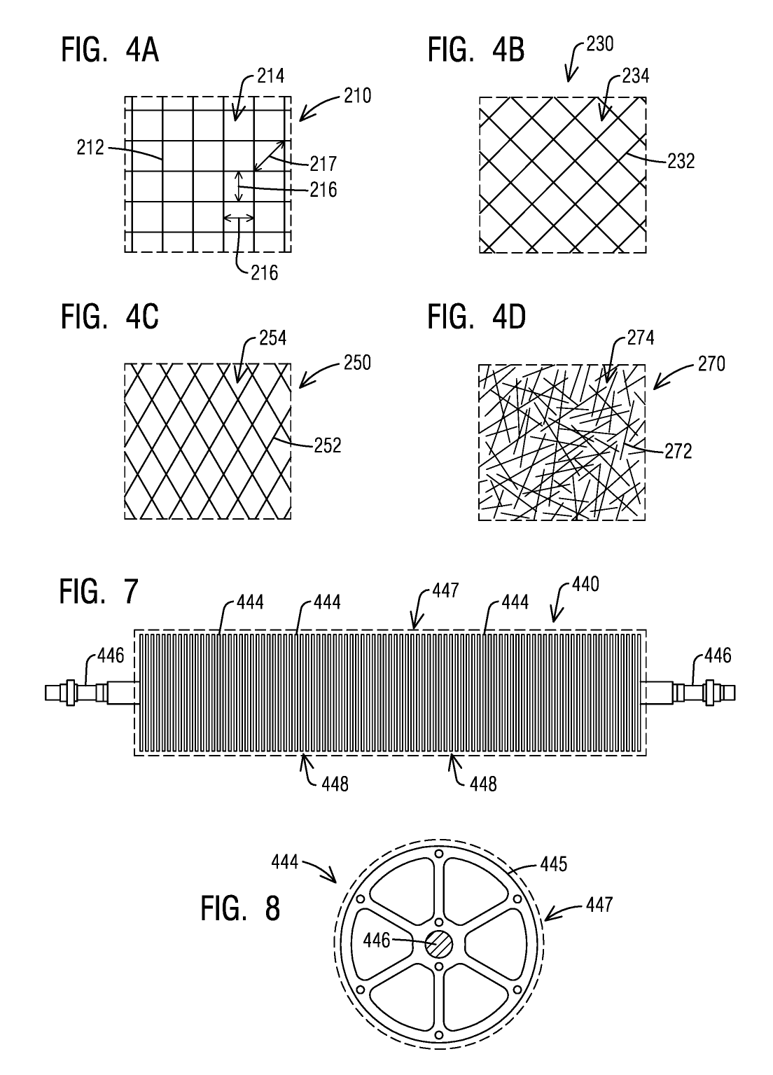

FIGS. 4A-4D are top views of the mesh layers of various embodiments of the composite sheet, and which serve to illustrate representative examples of some, but certainly not all, of the available mesh layer geometries. As shown in FIG. 4A, for instance, the mesh layer 210 can comprise crisscrossing threads or strands 212 that define a plurality of apertures 214. The open areas of the apertures 214 can be sufficiently large in size to allow the mesh layer 210 to be readily pushed or driven into the wet mixture of base sheet material during the initial formation stage of composite sheet. In one aspect, the open areas of the apertures can be greater than or equal to 10 mm², which is substantially equivalent to the open area of a ⅛″×⅛″ rectangular aperture. It is to be appreciated, however, that apertures of different size and shape are also possible and considered to fall within the scope of the present disclosure, as a desired aperture size can vary substantially with the viscosity and size of the free-floating fibers included with the initial aqueous stock material.

In one exemplary embodiment the crisscrossing strands 212 of the mesh layer 210 can be configured with a symmetric 4×4 weave (i.e. 4 strands per inch by 4 strands per inch) that results in square apertures 214 having side dimensions 216 of about 0.25 inches and a diagonal dimension 217 of about 0.35 inches, and which can provide substantially equal tensile strength reinforcement in both strand directions. However, it is to be appreciated that in other embodiments the strand count can be non-symmetric or increased in one direction relative to the strand count in the other direction (thereby providing tensile strength in that direction), or can also vary in one direction while remaining substantially constant in the other direction, to form rectangular apertures of varying sizes and shapes. As discussed above, the strands 212 of the mesh layer 210 can be woven or non-woven, can comprise multifilament or monofitament fibers, and can be spaced from each other by about ⅛″.

The strands 212 of the mesh layer 210 of FIG. 4A can be generally aligned with the length of the base sheet/composite sheet to provide the greatest reinforcement in directions that are aligned with and orthogonal to the length of the composite sheet. Alternatively, as shown in FIG. 4B, the strands 232 of the mesh layer 230 may also be angled relative to the length of the base sheet/composite sheet to provide the greatest reinforcement in directions that are oblique to the length or width of the composite. Further shown with the mesh layer 250 in FIG. 4C, the strands 252 need not intersect at right angles, but can interweave or cross at oblique angles that allow for the structural characteristics of the mesh 250 to be modified or optimized for an intended application. Similar to the mesh 210 depicted in FIG. 4A, the apertures 234 of the mesh 230 in FIG. 4B and the apertures 254 of the mesh 250 in FIG. 4C can be sized and shaped to be pushed or driven into the wet mixture of base sheet material of during initial formation of the composite sheet. In one aspect the apertures 234, 254 can generally have at least one dimension that is greater than or about 0.25 inches.

As shown in FIG. 4D, in yet another aspect the mesh layer 270 can comprise a pile or matrix of non-woven strands 272 that are randomly-oriented with respect to each other and to the length of the base sheet/composite sheet, and that may provide reinforcement that is substantially equal in all directions. As this can result in apertures 274 of irregular shaped and size, the mesh layer 270 can be constructed so that an average or median size of the apertures 274 is equal to or greater than a defined area value that has been predetermined to allow the mesh layer to be pushed or driven into the wet mixture of base sheet material during initial formation of the composite sheet.

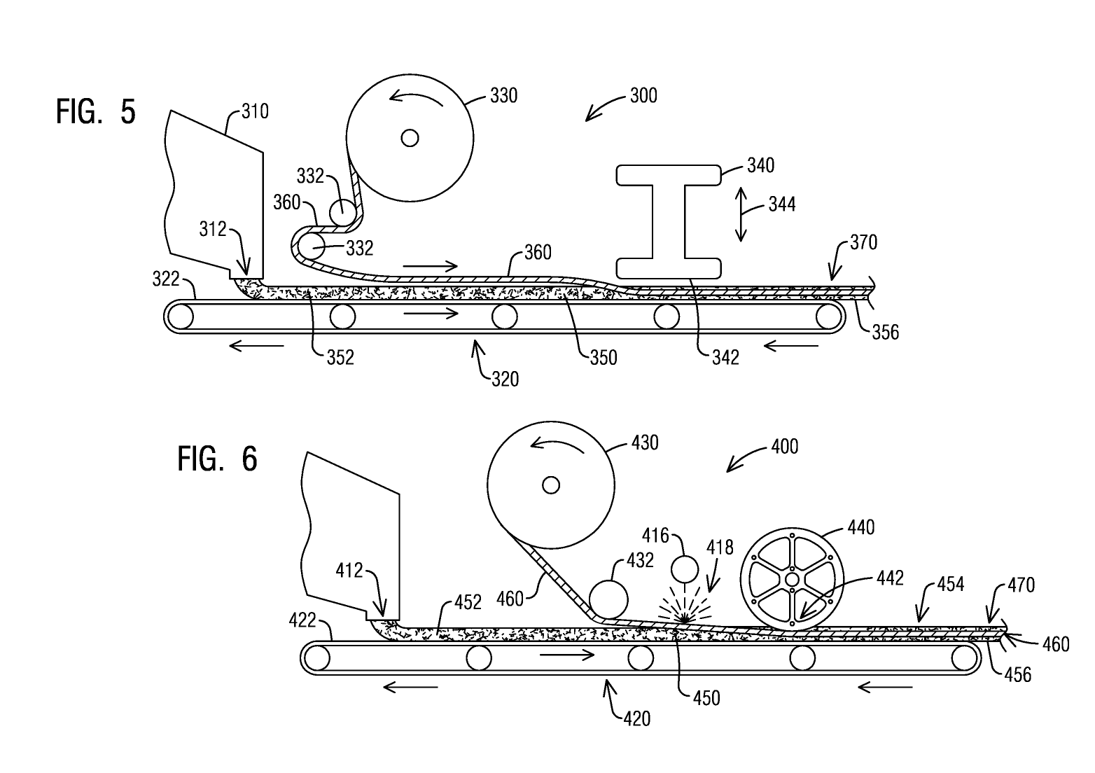

FIG. 5 is a schematic view of a system 300 and method for making the composite sheet 370, in accordance with yet another representative embodiment. The manufacturing system 300 generally includes a head box 310 for depositing a wet base layer 350 of stock material, in the form of a wet or aqueous slurry mixture 352, through outlet opening 312 and onto the moving top surface 322 of an endless wire run 320. As known to one of skill in the art, the water contained in the slurry mixture 352 then drops out through the wire run 320 or is withdrawn or extracted from the wet base layer 350, such as with a vacuum, to gradually transition the aqueous slurry mixture 352 of stock material into a consolidated, semi-solid base layer 356 that ultimately becomes the base sheet upon further processing and/or drying.

Also shown in FIG. 5, a reel 330 supporting a wound roll of the mesh layer 360 can be located above the wire run 320 and proximate to the head box 310. One or more secondary rollers 332 can be used to pull the mesh layer 360 from the reel 330 and to position the mesh layer 360 on top of the wet base layer 350 as it is carried downstream on the wire run 320. The wet base layer 350 and mesh layer 360 can then travel together underneath a reciprocating patter 340 having a contact surface 342 that is configured to drive the mesh layer 360 into the wet base layer 350, while still in the state of an aqueous slurry mixture 352, to a predetermined height or elevation above the top surface of the wire run 320, and at least until the underside portion of the mesh layer 360 is embedded within the stock material. Generally, however, the reciprocating patter 340 can drive the mesh layer 360 to a predetermined height in which the entire mesh layer 360 is embedded within the aqueous slurry mixture, with the upper surfaces of the mesh layer at or below the top surface of the wet base layer 350.

After placement of the mesh layer 360 within the wet base layer 350, the moisture with the slurry mixture 352 can continue to be withdrawn so that the aqueous stock material solidifies into the consolidated base layer 356 around the embedded mesh layer 360, thereby forming a damp composite sheet 370. In addition, the tension on the mesh layer 360 applied by the downstream portions of the damp composite sheet 370 can maintain the mesh layer 360 at the desired elevation until reaching a wet line, at which point the stock material consolidates and the position of the mesh layer 360 within the consolidated base layer 356 becomes fixed.

The stroke of the patter 340 can be adjustable so that the position of the embedded mesh layer 360 within the initial thickness of the wet base layer 350 can be positively controlled, which is not possible when the mesh layer 360 is combined with the wet base layer 350 at other locations in the paper making process. For example, if the mesh layer 360 were to be combined with the aqueous stock material within the head box 310, prior to deposition on the wire run, the dynamics of the slurry mixture would either cause the elevation of the mesh layer within the base layer to vary considerably along the length and width of the sheet, or would allow a mesh made of more buoyant material to float to the top of the wet base layer prior to reaching the wet line, thereby becoming fixed in an undesirable position.

Although the contact surface 342 of the patter 340 is depicted as a continuous surface in FIG. 5, it is to be appreciated that the contact surface 342 can also comprise multiple lines of contact extending parallel or perpendicular (or both) to the direction of motion of the wire run 320, with the lines of contact being separated by gaps that allow the wet slurry mixture 352 to flow readily upward through the apertures in the mesh layer 360 and into the gaps as the mesh layer is being pressed downward into the material of the wet base layer 350. In other aspects the contact surface 342 of the patter 340 may also be flat, inclined, or even curved relative to the top surface of the wire run 322, so as to provide additional control over the placement of the mesh layer 360 and to minimize any disruption of the wet slurry mixture 352 by the contact surface 342 of the patter 340.

In one aspect the reciprocating speed of the patter 340 may be adjusted relative to the lateral speed of the wire run 320 so that substantially all of the mesh layer 360 is contacted by the patter 340 at least once, while in other aspects substantially all of the mesh layer 360 can be contacted by the patter 340 more than once. The tension of the mesh layer 360 prior to reaching the reciprocating patter 340 can also be set only high enough, if necessary, to maintain the mesh layer substantially flat and wrinkle-free on top the moving layer of stock material, but still low enough to prevent the mesh layer from pulling back out of the wet base layer 350 after positioning by the patter. Furthermore, as discussed in more detail below, the mesh layer may also be set into the wet stock mixture using alternative equipment or methods, such as with an embed roll, through agitation of the wet base layer on the wire run to cause the mesh layer to settle into the aqueous stock material, and the like.

After the mesh layer 360 has been embedded within the wet slurry mixture 352, such as with the patter 340, the water within the wet base layer 350 can continue to be withdrawn or extracted through the wire run 320 until the base layer 350 has become sufficiently solidified or consolidated around the mesh layer 360 to form the damp composite sheet 370. The damp composite sheet 370 can then be withdrawn from the wire run 320 and passed through a press section of rollers (not shown but known to one of skill in the papermaking arts) to further compress or consolidate the damp stock material of the base layer 350 and to define the top surface, the bottom surface, and the final thickness of the base sheet that together with the mesh layer 360 ultimately forms the final composite sheet or substrate. As disclosed above, the thickness of the composite sheet is generally greater than the thickness of the mesh layer 360, although in some aspects the thickness of the composite sheet can be substantially equal to the thickness of the mesh layer.

As the damp consolidated sheet 370 is drawn into the press section of rollers, it was found during development of the invention that the consolidated base layer 356 of fibrous material will tend to extrude or stretch with compression while the embedded mesh layer 360, especially those mesh layers made of fiberglass or polymer material, will resist stretching. This creates the possibility that portions of the consolidated base layer 356 will be pushed or bunched together into surface ripples if the compression or pinch settings between the press rollers is excessive, or for the mesh layer 360 to pull out of the consolidated base layer 356 if the gain in speed between the sets of rollers at either end of the press section is set too high. Without being bound to any particular theory, it is contemplated that this incompatibility between the stretchable consolidated base layer and the non-stretchable mesh layer during a typical continuous sheet manufacturing process may be one reason why additional reinforcement layers were either stitched or laminated to the outside of the base layer in previous versions of reinforced composite sheets, rather than embedded or incorporated within the base layer as presented in the present disclosure. To overcome these problems, the inventors have discovered that the mesh layer 360 can remain embedded within the base layer material 356 and the deleterious ripples can be avoided with compression and gain settings that are substantially reduced in comparison to the compression and gain settings commonly used by those of skill in the paper-making arts for manufacturing simple low-cost sheet materials formed from wet stock mixtures of non-woven fibers.

After the press section, the damp composite sheet 370 can then be passed through a dryer section (not shown but also known to one of skill in the papermaking arts) to form the dry or finished composite sheet with an embedded mesh layer, with one or both of the sides of the mesh layer generally being positioned interior to the base sheet and spaced from the nearest of the top surface or the bottom surface of the base sheet. However, with the embodiments in which the thickness of the consolidated base layer 356 is substantially equal to the thickness of the mesh layer 360 at the end of the press section, the top surface or bottom surface of the base sheet material can be drawn inward slightly during drying, especially in the aperture portions of the mesh layer, so that the pattern of the mesh layer or even exposed strands can protrude outward from one or more surfaces of the dried base sheet, especially at the intersections between the strands.

Once dried, the composite sheet can be rolled onto reels for storage and/or transportation to additional manufacturing facilities or construction sites. The composite sheet can then be impregnated or coated with an additional material to form a final sheet-like product that meets the performance requirements of the intended application.

FIG. 6 is a schematic view of another embodiment of a system 400 and method for making the composite sheet, that also includes a head box 410 for depositing the wet base layer 450 of stock material, in the form of a wet or aqueous slurry mixture 452, through outlet opening 412 and onto the moving top surface 422 of an endless wire belt or wire run 420. As known to one of skill in the art, the moisture contained in the slurry mixture 452 then drops out through the wire run 420 or is withdrawn or extracted from the stock material, such as with a vacuum, to gradually transition the slurry mixture 452 into the consolidated base layer 456.

A reel 430 supporting a wound roll of the scrim or mesh layer 460 can be located above the wire run 420 and proximate to the head box 410. One or more secondary rollers 432 can be used to pull or carry the mesh layer 460 from the reel 430 and to position the mesh layer 460 adjacent top surface of the wet base layer 450 as it is carried downstream on the wire run 420 toward an embed roller 440 that is immediately adjacent to or even contacting the wet base layer 450. Although illustrated on the schematic drawing of FIG. 6 as being downstream of the head box 410, it is to be appreciated that the reel 430 could also be positioned on the opposite side of the head box and within a loading/splicing apparatus that can sequentially withdraw the scrim or mesh layer 460 from two or more reels without interruption, thereby allowing for the mesh layer to be continuously combined with the wet base layer 450 during the continuous manufacturing process.

The location of the embed roller 440 along the length of the wire run 420 can be upstream or prior to the wet line 454 which, as discussed above, is generally considered to be the point in the manufacturing process at which the aqueous stock material forming the wet base layer 450 transitions from the slurry mixture 452 into a semi-solid comprising the consolidated base layer 456. In one aspect, the embed roller 440 can be positioned one or more meters upstream or prior to the wet line 454 so that the scrim or mesh layer 460 can be easily pressed into the wet base layer 450 by the embed roller 440, with the slurry mixture 452 flowing through the apertures and around the strands that form the mesh layer 460, as described above. With the mesh layer 460 being combined with the wet base layer 450 while it is still substantially flowable, the stock material has time to flow back and fill in any gaps or indentations that may have formed during placement of the mesh layer 460, and the fibers within the wet stock mixture have time to become re-oriented and connected around the individual strands of the mesh layer 460 in a manner that will provide a secure connection upon solidification of the wet base layer 450 into the consolidated base layer 456.

In one aspect, an optional water shower 416 can also be positioned above the wire run 420 immediately upstream of embed roller 440. The water shower 416 can be configured to direct a plurality of high pressure water jets 418 down onto the mesh layer 460 and top surface of the wet base layer 450 to loosen and “turbulate” the upper portions of the fibrous stock material to make it more flowable, thereby allowing the mesh layer to settle further into wet base layer and while simultaneously distributing the fibrous stock material around and across the upper surfaces of the mesh layer, prior to reaching the embed roller 440.

The gap between the top surface 422 of the wire run 420 and the contact portion 442 of the rotating embed roller 440 can be adjustable in order to positively control the positioning the mesh layer 460 within the wet base layer 450 of stock material. In this way the scrim or mesh layer 460 can be driven into the wet base layer 450 to a predetermined height, and at least until an underside of the mesh layer 460 is embedded within the stock material below the top surface of the wet base layer 450. As previously discussed, the positive positioning of the mesh layer at a predetermined height is not possible when the mesh layer 460 is combined with the wet base layer 450 at other locations in the paper making process, such as within the head box 410. In some embodiments, such as the composite sheet 10 or substrate shown in FIG. 1, it may be desirable for the mesh layer to be entirely embedded within the consolidated base layer 456.

In order to drive the mesh layer 460 completely into the wet base layer 450 of aqueous stock material using the embed roller 440 of FIG. 6, and without unduly compressing or redistributing the wet slurry mixture 456, the embed roller 440 can be constructed as shown in FIGS. 7-8. In this embodiment the embed roller 440 can be formed from a plurality of circular wafers 444 that have been stacked and bolted together along an axle or shaft 446, with each of the plurality of stacked circular wafers 444 having a roller edge 445 that is spaced from the roller edges 445 of adjacent circular wafers 444 by radial gaps 448. Upon assembly, the plurality of roller edges 445 together define a partially cylindrical contact surface 447, in which the combined contact surface area of the roller edges is sufficient to drive or set the mesh layer 460 within the wet base layer 450, while the radial gaps 448 between the circular wafers 444 provide open volumes that allow the wet slurry mixture 452 to flow between and around the circular wafers 444 without substantial redistribution. In one aspect the thickness of the circular wafers 444 can be about 0.04 inches, while the radial gaps 448 between the circular wafers 444 when stacked along the axle 446 can be about 0.5 inches. Other dimensions for the wafers and the spacing between wafers are also possible. As shown in FIG. 6, for instance, the contact portion 442 of the embed roller 440, in this case the partially cylindrical contact surface 447 described above, can extend into the flowable mixture 452 and below the top surface to deposit the mesh layer 460 into the central portion of the wet base layer 450.

After the positive positioning of the scrim or mesh layer 460 at the predetermined height within the wet base layer 450, the tension on the mesh layer 460 applied by the downstream portions of the damp composite sheet 470 can maintain the mesh layer 460 at the desired height or elevation until reaching the wet line 454, after which the position or elevation of the embedded mesh layer 460 within the consolidated base layer 456 becomes fixed. In addition, the tension on the mesh layer 460 between the secondary rollers 432 upstream of the embed roller and the embed roller 440 can be controlled to a level that is sufficient, if necessary, to maintain the mesh layer substantially flat and fold-free above the moving layer of stock material, but still low enough to prevent any individual strands on the upper side of the mesh layer that happen to fall between the wafers of the embed roller from being pulled off the mesh layer as it is being positioned within the wet base layer by the embed roller.

After solidification of the stock material into the consolidated base layer 456 on the other side of the wet line 454, the damp composite sheet 470 can then be withdrawn from the wire run 420 and passed through a press section of rollers to further compress the stock material and to define the top surface, the bottom surface, and the final thickness of the damp composite sheet 470, followed by a dryer section to form the dry or finished composite sheet or substrate with the mesh layer embedded within the base sheet.

As discussed above, in one aspect both sides of the mesh layer 460 can be positioned interior to the outer surfaces of the base sheet along the length of the composite sheet. In other aspects the natural variability in the manufacturing process can allow for the depth or position of the mesh layer 460 to vary within the thickness of the base sheet, so that the strands of the mesh layer 460 may become visible at the outer surfaces of the solidified and dried base sheet at various locations along the length of the composite sheet.

In yet another embodiment (not shown), it is also contemplated that the embed roller can have a substantially solid or continuous cylindrical contact surface. particularly in a manufacturing process in which the mesh layer is only partially embedded within the base layer, and in which the contact portion of the embed roller is spaced above the top surface of the base layer.

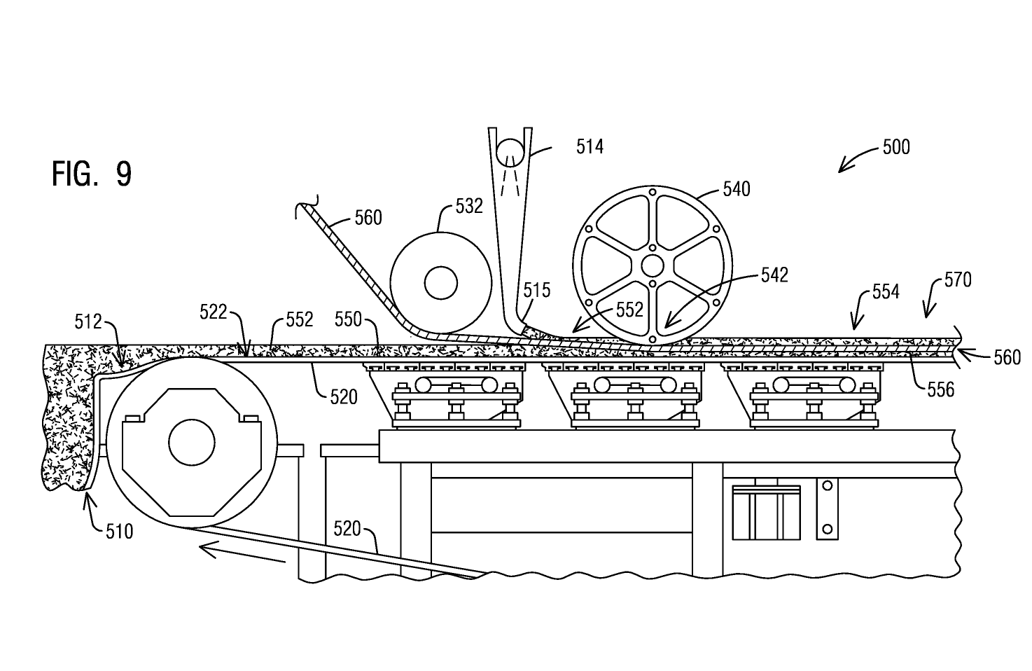

FIG. 9 is a side view of another representative embodiment of the system 500 and process for making the composite sheet in which the head box 510 is located at the upstream end of the wire run 520 and on a level with the moving top surface 522 of the wire run 520. In this configuration the slurry mixture overflows a projecting lip or apron 512 of the head box 510 and onto the top surface 522 to form a wet base layer 550 of aqueous stock material 552 that is carried downstream underneath a secondary roller 532 that is located above the wet base layer 550. The secondary roller can be used to position the scrim or mesh layer 560 slightly above the top surface of the wet base layer 550 and to control the tension on the mesh layer 560 between the secondary roller 532 and the embed roller 540, as described above. As the wet base layer 550 and mesh layer 560 continue to travel together downstream toward the embed roller 540, a manifold 514 having a lower end with a nozzle outlet 515 positioned above the wire run 520 can be used to deposit an additional layer of slurry mixture on top the base layer 550 and mesh layer 560, so as to substantially cover and embed the mesh layer with the aqueous stock material 552 prior to reaching the embed roller 540. In one aspect the amount of additional slurry mixture deposited through the nozzle outlet 515 can comprise about 25% of the total aqueous stock material 552.

The embed roller 540 can then be used to positively position the mesh layer 560 at the desired height or elevation within the wet base layer 550 and to smooth out and distribute the aqueous stock material 552 across the base sheet prior to reaching the wet line 554. After consolidation of the stock material into the semi-solid base layer 556 on the other side of the wet line 554, the damp composite sheet 570 can then be withdrawn from the wire run 520 and passed through a press section and a dryer section to form the dry or finished composite sheet or substrate with the mesh layer embedded within the base sheet, as indicated above.

The invention has been described herein in terms of preferred embodiments and methodologies considered by the inventor to represent the best mode of carrying out the invention. It will be understood by the skilled artisan, however, that a wide range of additions, deletions, and modifications, both subtle and gross, may be made to the illustrated and exemplary embodiments of the composite sheet without departing from the spirit and scope of the invention. These and other revisions might be made by those of skill in the art without departing from the spirit and scope of the invention that is constrained only by the following claims.

1. A composite sheet comprising:
a base sheet comprising a single ply of dried stock material including at least one of non-woven natural fibers and non-woven synthetic fibers and having a top surface, a bottom surface, and a base sheet thickness between the top surface and the bottom surface; and
a mesh layer formed from a plurality of intersecting strands to define a mesh layer thickness as measured at the intersections thereof, with at least a majority portion of the mesh layer thickness being embedded within the base sheet thickness,
wherein the mesh layer thickness is at least about ⅓ the base sheet thickness.

2. The composite sheet of claim 1, wherein the mesh layer is substantially embedded within the base sheet with an upper surface of the mesh layer at the top surface of the base sheet, with the pattern of the embedded mesh layer projecting upward through the dried stock material at the top surface of the base sheet.

3. The composite sheet of claim 1, wherein the stock material further comprises at least about 50% cellulose by weight.

4. The composite sheet of claim 1, wherein the stock material further comprises between about 60% and 100% cellulose by weight.

5. The composite sheet of claim 1, wherein the stock material is absorbent to at least one second material.

6. The composite sheet of claim 5, wherein the at least one second material further comprises an asphalt or bitumen-based material.

7. The composite sheet of claim 5, wherein the dried stock material has a kerosene absorption number greater than about 120.

8. The composite sheet of claim 1, wherein the strands of the mesh layer further comprise a multifilament fiberglass material.

9. The composite sheet of claim 1, wherein the strands of the mesh layer are formed from a polymer-based material.

10. The composite sheet of claim 1, wherein the strands of the mesh layer are formed from a natural fiber material.

11. The composite sheet of claim 1, wherein the base sheet thickness ranges from about 0.005 inches to about 0.062 inches.

12. The composite sheet of claim 1, wherein the mesh layer thickness ranges from about 0.005 inches to about 0.030 inches.

13. The composite sheet of claim 1, wherein the mesh layer is formed from a plurality of crisscrossing strands to define a plurality of apertures having open areas greater than or about 10 mm².

14. The composite sheet of claim 1, wherein the mesh layer further comprises a matrix of non-woven strands.

15. A composite sheet comprising:
a base sheet comprising a single ply of dried stock material including at least one of non-woven natural fibers and non-woven synthetic fibers and having a top surface, a bottom surface, and a base sheet thickness between the top surface and the bottom surface; and
a scrim extending across a width and a length of the base sheet and formed from a plurality of intersecting strands of a multifilament fiberglass material to define a scrim thickness at the intersections thereof, the scrim being substantially embedded within an upper portion of the base sheet with the pattern of the embedded intersecting strands projecting upward through the dried stock material at the top surface of the base sheet.

16. The composite sheet of claim 15, wherein the scrim thickness is at least about ⅓ the base sheet thickness.

17. The composite sheet of claim 15, wherein the dried stock material further comprises at least about 50% cellulose by weight.

18. The composite sheet of claim 15, wherein the dried stock material is absorbent to an asphalt or bitumen-based material.

19. The composite sheet of claim 18, wherein the dried stock material has a kerosene absorption number greater than about 120.

20. The composite sheet of claim 15, wherein the scrim thickness ranges from about 0.007 inches to about 0.010 inches.

21. The composite sheet of claim 15, wherein the base sheet thickness ranges from about 0.016 inches to about 0.024 inches.

22. The composite sheet of claim 15, wherein the plurality of intersecting strands further define a plurality of apertures having open areas greater than or about 10 mm².

23. A method of making a composite sheet, the method comprising:
depositing aqueous stock material including at least one of non-woven natural fibers and non-woven synthetic fibers onto a translating wire run to form a wet base layer having a thickness and a top surface;
prior to a wet line at which the aqueous stock material transitions into a consolidated material, setting a mesh layer having a mesh layer thickness into the wet base layer at least until a majority portion of the mesh layer thickness is embedded within the aqueous stock material below the top surface of the base layer;
passing the consolidated base layer with the embedded mesh layer through a press section of rollers to define a damp composite sheet; and
passing the damp composite sheet through a dryer section to form a composite sheet comprising the mesh layer and dried stock material having a top surface, a bottom surface, and a sheet thickness between the top surface and the bottom surface,
wherein the mesh layer thickness is at least about ⅓ the sheet thickness, and at least a majority portion of the mesh layer thickness is embedded within the sheet thickness.

24. The method of claim 23, wherein the mesh layer thickness is substantially equal to the sheet thickness.

25. The method of claim 23, wherein setting the mesh layer further comprises:
positioning the mesh layer adjacent the top surface of the wet base layer; and
driving the mesh layer into the aqueous stock material with a reciprocating patter.

26. The method of claim 22, wherein setting the mesh layer further comprises driving the mesh layer into the wet base layer with an embed roller.

27. The method of claim 26, wherein the embed roller further comprises a partially cylindrical contact surface that extends below the top surface of the wet base layer to drive an upper surface of the mesh layer below the top surface of the wet base layer.

28. The method of claim 26, wherein the embed roller is formed from a plurality of circular wafers stacked along a longitudinal axis, the plurality of stacked circular wafers having a plurality of roller edges spaced by a plurality of radial gaps to define a partially cylindrical contact surface.

29. The method of claim 23, wherein setting the mesh layer further comprises agitating the wet base layer to cause the mesh layer to settle into the aqueous stock material.

30. The method of claim 23, further comprising setting the mesh layer into the wet base layer until an upper side of the mesh layer is substantially coplanar with the top surface of the base layer.
